(19) United States
(12) Patent Application Publication
(10) Pub. No.: US 2020/0351088 A1
(43) Pub. Date: Nov. 5, 2020

(54) SYSTEM AND METHOD FOR MANAGING CERTIFICATION FOR WEBPAGE SERVICE SYSTEM

(71) Applicant: TRUSTVIEW INC., Taipei (TW)

(72) Inventor: Yueh-Young TSAI, Taipei (TW)

(21) Appl. No.: 16/860,202

(22) Filed: Apr. 28, 2020

(30) Foreign Application Priority Data
May 3, 2019 (TW) 108115428

(51) Int. Cl. H04L 9/32; H04L 9/08; H04L 29/06; H04L 29/08

(52) U.S. Cl. CPC H04L 9/321; H04L 9/0894; H04L 67/025; H04L 63/0428; H04L 9/0866

(57) ABSTRACT

A managing system and a managing method, according to the invention, are for managing certification for a webpage service system. When a user operates a data processing apparatus to execute a browser application to link to the webpage service system, a security agent device randomly generates a key in accordance with at least one characteristic data associated with the data processing apparatus, encrypts an original cookie data into an encrypted cookie data by using the key, writes the encrypted cookie data into an HTTP information to replace the original cookie data, and then transmits the HTTP information including the encrypted cookie data to the browser application.

### CROSS-REFERENCE TO RELATED APPLICATION

This utility application claims priority to Taiwan Application Serial Number 108115428, filed May 3, 2019, which is incorporated herein by reference.

### BACKGROUND OF THE INVENTION

### 1. Field of the Invention

The invention relates to a managing system and a managing method for managing certification for a webpage service system, and more in particular, to a managing system and managing method for managing certification for a webpage service system by use of encrypting and decrypting cookie data in a third-party manner.

### 2. Description of the Prior Art

At present, various webpage service systems have mechanisms for providing identity certification. These webpage service systems also have security mechanisms for identity certification. Various webpage service systems include intranet web servers, public cloud service servers and so on.

However, no matter how prolonged these security mechanisms for identity certification are, if the data processing device operated by the user has been hacked by malicious programs, these malicious programs can steal cookie data stored in the browser application. Moreover, before the connection has expired, if a malicious person operates a data processing apparatus to store the cookie data, stolen on another data processing apparatus in the browser, and to link to the webpage service system again, he can fraudulently use identity to obtain certification.

A prior art of Taiwan Patent issued No. 1592824 discloses a data processing system capable of securing files. The data processing system of the prior art divides a storage device into a protected space and an unprotected space, and therefore, data the processing system of the prior art can prevent users from stealing or destroying the data stored in the protected space, and can also prevent users from stealing or destroying the data stored in the remote system linked to the data processing system. However, if a user operates the browser application in the protected space to obtain the cookie data and operates the browser application in the unprotected space to type or copy the cookie data before the connection has expired, the user can avoid the safety protection mechanism operating in the protection space and obtain the certification for the webpage service system, and then steal the data stored in the webpage service system.

### SUMMARY OF THE INVENTION

Accordingly, one scope of the invention is to provide a managing system and a managing method for managing certification for a webpage service system. In particular, the managing system and the managing method according to the invention encrypt and decrypt cookie data in a third-party manner to prevent malicious intruders from fraudulently using their identities to obtain certification for the webpage service system, and to prevent users from bypassing the original security mechanism of data processing systems to obtain the certification for the webpage service system.

A managing system according to a preferred embodiment of the invention is for managing certification for a webpage service system, and includes a data processing apparatus and a security agent device. The data processing apparatus is capable of being linked to the webpage service system through a network. The data processing apparatus includes a data storage unit and at least one processor. A browser application is stored in the data storage unit. The at least one processor is electrically connected to the data storage unit. The security agent device is capable of communicating with the data processing apparatus. The security agent device includes a communication module, a record module and a data processing module. The data processing module is respectively coupled to the communication module and the record module. When a user operates the at least one processor to execute the browser application to link to the webpage service system, the at least one processor makes the browser application to link to the webpage service system through the security agent device and the network. The browser application transmits a first connection request information to the security agent device. The first connection request information includes at least one characteristic data associated with the data processing apparatus. The data processing apparatus receives the first connection request information through the communication module, and then performs the steps of: generating a connection characteristic information in accordance with the at least one characteristic data; generating a salt in accordance with the connection characteristic information and a time; randomly generating a key in accordance with the salt; storing the connection characteristic information and the key into the record module; and forwarding the first connection request information to the webpage service system through the communication module and the network. The webpage service system generates a first hypertext transfer protocol (HTTP) information in response to the first connection request information, and transmits the first HTTP information to the data processing module through the network and the communication module. Then, the data processing module performs the steps of: analyzing the first HTTP information to extract a first cookie data associated with the data processing apparatus from the first HTTP information; encrypting the first cookie data into an encrypted first cookie data by using the key; writing the encrypted first cookie data into the first HTTP information to replace the first cookie data being unencrypted in the first HTTP information; and transmitting the first HTTP information including the encrypted first cookie data to the browser application through the communication module.

Further, when the user operates the at least one processor to execute the browser application to continuously link to the webpage service system, the browser application transmits a second connection request information to the security agent device. The second connection request information includes the encrypted first cookie data and the at least one characteristic data associated with the data processing apparatus. The data processing module receives the second connection request information through communication module and then performs the steps of: generating the connection characteristic information in accordance with the at least one characteristic data; retrieving the key stored in the record module in accordance with the connection characteristic information; decrypting the encrypted first cookie data into the first cookie data being unencrypted by using the key; writing the first cookie data being unencrypted into the second connection request information to replace the encrypted first cookie data in the second connection request information; and forwarding the second connection request information to the webpage service system through the communication module and the network. The webpage service system generates a second HTTP information in response to the second connection request information, and transmits the second HTTP information to the data processing module through the network and the communication module. Then, the data processing module performs the steps of: analyzing the second HTTP information to extract a second cookie data associated with the data processing apparatus from the second HTTP information; encrypting the second cookie data into an encrypted second cookie data by using the key; writing the encrypted second cookie data into the second HTTP information to replace the second cookie data being unencrypted in the second HTTP information; and transmitting the second HTTP information including the encrypted second cookie data to the browser application through the communication module.

A managing method, according to a preferred embodiment of the invention, is for managing certification for a webpage service system, and has an implementation architecture in which a data processing apparatus is capable of being linked to the webpage service system through a network. The data processing apparatus includes a data storage unit and at least one processor. A browser application is stored in the data storage unit. The at least one processor is electrically connected to the data storage unit. The managing method according to the invention is, firstly, to link the browser application, by use of the at least one processor, to the webpage service system through a security agent device and the network when a user operates the at least one processor to execute the browser application to link to the webpage service system, where the security agent device includes a record module. Next, the managing method according to the invention is to transmit a first connection request information, by the browser application, to the security agent device, where the first connection request information includes at least one characteristic data associated with the data processing apparatus. Then, the managing method according to the invention is to perform, by the security agent device, the steps of: generating a connection characteristic information in accordance with the at least one characteristic data; generating a salt in accordance with the connection characteristic information and a time; randomly generating a key in accordance the salt; storing the connection characteristic information and the key into the record module; and forwarding the first connection request information to the webpage service system through the network. Subsequently, the managing method according to the invention is, by the webpage service system, to generate a first hypertext transfer protocol (HTTP) information in response to the first connection request information, and to transmit the first HTTP information to the security agent device through the network. Finally, the managing method according to the invention is to perform, by the security agent device, the steps of: analyzing the first HTTP information to extract a first cookie data associated with the data processing apparatus from the first HTTP information; encrypting the first cookie data into an encrypted first cookie data by using the key; writing the encrypted first cookie data into the first HTTP information to replace the first cookie data being unencrypted in the first HTTP information; and transmitting the first HTTP information including the encrypted first cookie data to the browser application.

Further, the managing method according to the invention is also to transmit a second connection request information, by the browser application, to the security agent device when the user operates the at least one processor to execute the browser application to continuously link to the webpage service system, where the second connection request information includes the encrypted first cookie data and the at least one characteristic data associated with the data processing apparatus. Next, the managing method according to the invention is to perform, by the security agent device, the steps of: generating the connection characteristic information in accordance with the at least one characteristic data; retrieving the key stored in the record module in accordance with the connection characteristic information; decrypting the encrypted first cookie data into the first cookie data being unencrypted by using the key; writing the first cookie data being unencrypted into the second connection request information to replace the encrypted first cookie data in the second connection request information; and forwarding the second connection request information to the webpage service system through the network. Then, the managing method according to the invention is, by the webpage service system, to generate a second HTTP information in response to the second connection request information, and transmitting the second HTTP information to the security agent device through the network. Finally, he managing method according to the invention is to perform, by the security agent device, the steps of: analyzing the second HTTP information to extract a second cookie data associated with the data processing apparatus from the second HTTP information; encrypting the second cookie data into an encrypted second cookie data by using the key; writing the encrypted second cookie data into the second HTTP information to replace the second cookie data being unencrypted in the second HTTP information; and transmitting the second HTTP information including the encrypted second cookie data to the browser application.

In one embodiment, the webpage service system can be a first intranet web server or a first public cloud service server.

In one embodiment, the security agent device can be a security agent application stored in the data storage unit, a second intranet server or a second public cloud service server.

In one embodiment, the at least one characteristic data includes an IP (internet protocol) address, a MAC (media access control) address, a user agent, an XFH (X-Forwarded-Host) request header, a mobile phone number, a user identification code, a user identity module identification code, and so on.

Compared to the prior art, the managing system and the managing method according to the invention encrypt and decrypt cookie data in a third-party manner such that the browser application receives the encrypted cookie data. Thereby, the managing system and the managing method according to the invention can prevent malicious intruders from fraudulently using their identities to obtain certification for the webpage service system, and can prevent users from bypassing the original security mechanism of the data processing system to obtain the certification for the webpage service system.

The advantage and spirit of the invention may be understood by the following recitations together with the appended drawings.

### BRIEF DESCRIPTION OF THE APPENDED DRAWINGS

FIG. 1 is a schematic diagram of a managing system for managing certification for a webpage service system and an implementation architecture thereof in accordance with the preferred embodiment of the invention.

FIG. 2 is a functional block diagram of the managing system for managing certification for the webpage service system in accordance with the preferred embodiment of the invention.

FIG. 3 is a schematic diagram of a managing system for managing certification for a webpage service system and an implementation architecture thereof in accordance with one modification of the preferred embodiment of the invention.

FIG. 4 is a functional block diagram of the managing system as shown in FIG. 3.

FIG. 5 is a functional block diagram of the managing system according to another modification of the preferred embodiment of the invention.

FIG. 6 is a flow diagram illustrating a managing method for managing certification for a webpage service system according to the preferred embodiment of the invention.

FIG. 7 is another flow diagram illustrating the managing method for managing certification for the webpage service system according to the preferred embodiment of the invention.

### DETAILED DESCRIPTION OF THE INVENTION

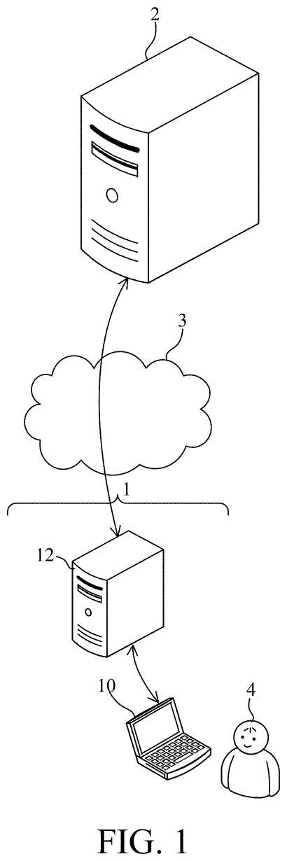

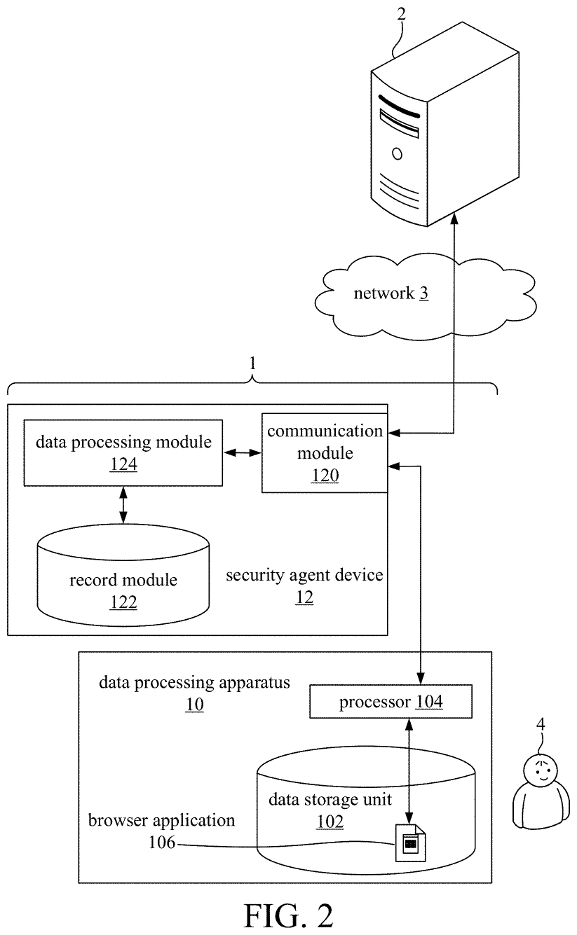

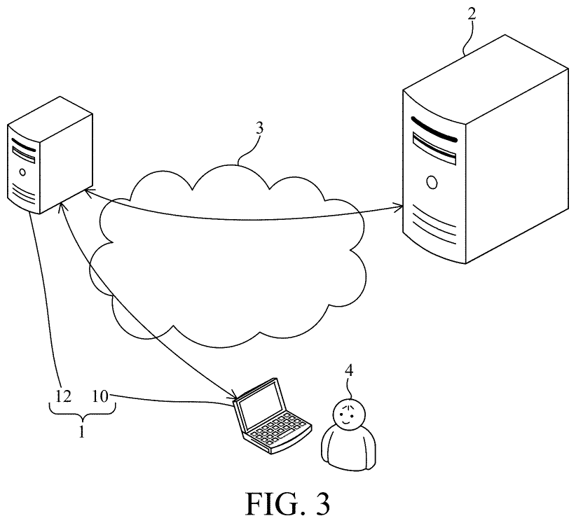

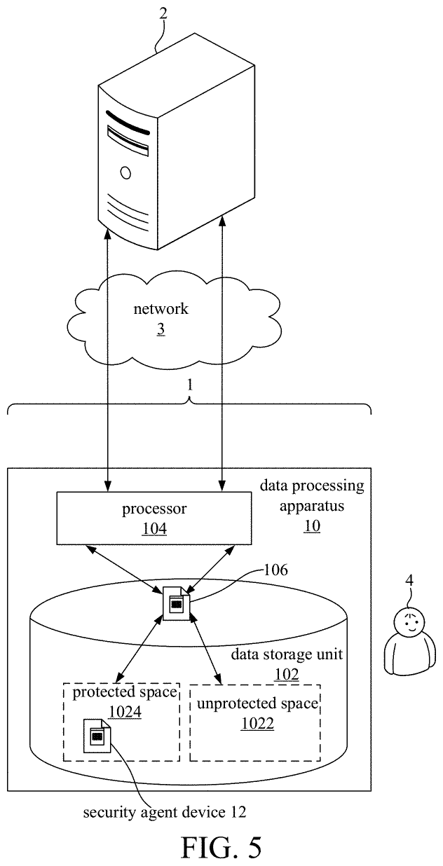

Referring to FIGS. 1 to 5, a managing system 1, according to the preferred embodiment of the invention, for managing certification for a webpage service system 2 and an implementation architecture thereof is illustratively shown in FIG. 1. FIG. 2 is a functional block diagram of the managing system 1, as shown in FIG. 1, for managing certification for the webpage service system 2. The managing system 1, according to a modification of the preferred embodiment of the invention, for managing certification for a webpage service system 2 and an implementation architecture thereof is illustratively shown in FIG. 3. FIG. 3 is a functional block diagram of the managing system 1, as shown in FIG. 3, for managing certification for the webpage service system 2. FIG. 5 is a functional block diagram of the managing system 1, according to another modification of the preferred embodiment of the invention, for managing certification for the webpage service system 2.

As shown in FIG. 1 and FIG. 2, the managing system 1, according to the preferred embodiment of the invention, for a webpage service system 2 includes a data processing apparatus 10 and a security agent device 12. The data processing apparatus 10 is capable of being linked to the webpage service system 2 through a network 3.

In one embodiment, the network 3 can be an intranet, an internet, an extranet, a local area network, a wide area network, an Ethernet, a cable TV network, a radio telecommunication network, a public switched telephone network, a 3G network, a 4G network, a 5G networks, a 6G network, an HSPA networks, a Wi-Fi networks, a WiMAX networks, an LTE networks, or other popular commercial public networks.

In one embodiment, the data processing apparatus 10 can be various data processing apparatus, such as a notebook computer, a desktop computer, a tablet PC, a smart phones, and so on.

The data processing apparatus 10 includes a data storage unit 102 and at least one processor 104. A browser application 106 is stored in the data storage unit 102. The at least one processor 104 is electrically connected to the data storage unit 102.

In one embodiment, the browser application 106 can be Internet Explorer (IE) browser or Chrome browser running on a desktop or laptop computer, Safari browser running on an Apple-branded mobile phone, or Chrome browser running on a mobile phone running an android operating system.

The security agent device 12 is capable of communicating with the data processing apparatus 10. The security agent device 12 includes a communication module 120, a record module 122 and a data processing module 124. The data processing module 124 is respectively coupled to the communication module 120 and the record module 122.

When a user 4 operates the at least one processor 104 to execute the browser application 106 to link to the webpage service system 2, the at least one processor 104 makes the browser application 106 to link to the webpage service system 2 through the security agent device 12 and the network 3. The browser application 106 transmits a first connection request information to the security agent device 12. The first connection request information includes at least one characteristic data associated with the data processing apparatus 10.

The data processing apparatus 10 receives the first connection request information through the communication module 120, and then performs the steps of: generating a connection characteristic information in accordance with the at least one characteristic data; randomly generating a key where the connection characteristic information corresponds to the key; storing the connection characteristic information and the key into the record module 122; and forwarding the first connection request information to the webpage service system 2 through the communication module 120 and the network 3.

In one embodiment, the data processing module 124 generates a salt in accordance with the connection characteristic information and a time, and randomly generates the key in accordance with the salt.

The webpage service system 2 generates a first hypertext transfer protocol (HTTP) information in response to the first connection request information, and transmits the first HTTP information to the data processing module 124 through the network 3 and the communication module 120.

Then, the data processing module 124 performs the steps of: analyzing the first HTTP information to extract a first cookie data associated with the data processing apparatus 10 from the first HTTP information; encrypting the first cookie data into an encrypted first cookie data by using the key; writing the encrypted first cookie data into the first HTTP information to replace the first cookie data being unencrypted in the first HTTP information; and transmitting the first HTTP information including the encrypted first cookie data to the browser application 106 through the communication module 120.

In one embodiment, the at least one characteristic data includes an IP (internet protocol) address, a MAC (media access control) address, a user agent, an XFH (X-Forwarded-Host) request header (non-standard request header of HTTP information), a mobile phone number, a user identification code, a user identity module identification code, and son on.

Further, when the user 4 operates the at least one processor 104 to execute the browser application 106 to continuously link to the webpage service system 2, the browser application 106 transmits a second connection request information to the security agent device 12. The second connection request information includes the encrypted first cookie data and the at least one characteristic data associated with the data processing apparatus 10. The data processing module 124 receives the second connection request information through communication module 120 and then performs the steps of: generating the connection characteristic information in accordance with the at least one characteristic data; retrieving the key stored in the record module 122 in accordance with the connection characteristic information; decrypting the encrypted first cookie data into the first cookie data being unencrypted by using the key; writing the first cookie data being unencrypted into the second connection request information to replace the encrypted first cookie data in the second connection request information; and forwarding the second connection request information to the webpage service system 2 through the communication module 120 and the network 3. The webpage service system 2 generates a second HTTP information in response to the second connection request information, and transmits the second HTTP information to the data processing module 124 through the network 3 and the communication module 120. Then, the data processing module 124 performs the steps of: analyzing the second HTTP information to extract a second cookie data associated with the data processing apparatus 10 from the second HTTP information; encrypting the second cookie data into an encrypted second cookie data by using the key; writing the encrypted second cookie data into the second HTTP information to replace the second cookie data being unencrypted in the second HTTP information; and transmitting the second HTTP information including the encrypted second cookie data to the browser application 106 through the communication module 120.

In one embodiment, the webpage service system 2 can be a first intranet web server or a first public cloud service server.

In one embodiment, as shown in FIG. 1 and FIG. 2, the security agent device 12 can be a second intranet server. The communication module 120, the record module 122 and the data processing module 124 can be hardware elements in the security agent device 12.

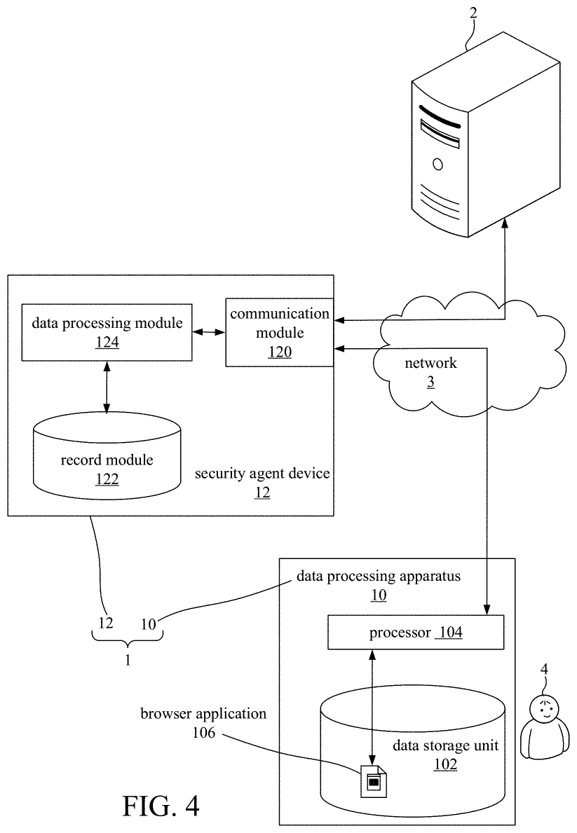

In another embodiment, as shown in FIG. 3 and FIG. 4, the security agent device 12 can be a second public cloud service server. The security agent device 12 is capable of linking to the data processing apparatus 10 through the network 3 or another network. The communication module 120, the record module 122 and the data processing module 124 can be hardware elements in the security agent device 12.

In another embodiment, as shown in FIG. 5, the security agent device 12 can be a security agent application stored in the data storage unit 102. In the example as shown in FIG. 5, the data storage unit 102 is divided into an unprotected space 1022 and a protected space 1024. The browser application 106 is stored in the data storage unit 102. The security agent device 12 implemented as a security agent application is stored in the protected space 1024 of the data storage unit 102. When the user 4 operates the at least one processor 104 to execute a protected start-up procedure to start up the browser application 106 stored in the data storage unit 102, the security agent device 12, implemented as the security agent application, stored in the protected space 1024 of the data storage unit 102 is simultaneously started up. During the connection process between the browser application 106 and the webpage service system 2, the browser application 106 receives the encrypted first cookie data or the encrypted second cookie data. If the user 4 operates in the unprotected space 1022 to type or copy the encrypted first cookie data or the encrypted second cookie data, the certification for the webpage service system 2 cannot be obtained since there is no security agent device 12 to assist in the decryption of the encrypted first cookie data or the encrypted second cookie data.

Thereby, the managing system 1 according to the invention can prevent malicious intruders from fraudulently using their identities to obtain certification for the webpage service system 2. If the malicious intrusion program obtains the encrypted first cookie data or the encrypted second cookie data in the browser application 106, and the encrypted first cookie data or the encrypted second cookie data are stored in the browser of another data processing apparatus to intentionally obtain the certification for the webpage service system 2, the fraudulent certification will not succeed since the webpage service system 2 cannot interpret the encrypted first cookie data or the encrypted second cookie data. Even if a malicious intruder can operate another data processing apparatus to connect to the security agent device 12, the security agent device 12 retrieves the characteristic data associated with the another data processing apparatus different from the characteristic data associated with the original data processing device 10, the encrypted first cookie data or the encrypted second cookie data cannot be decrypted successfully, and so the original identity cannot be used to obtain the certification for the webpage service system 2.

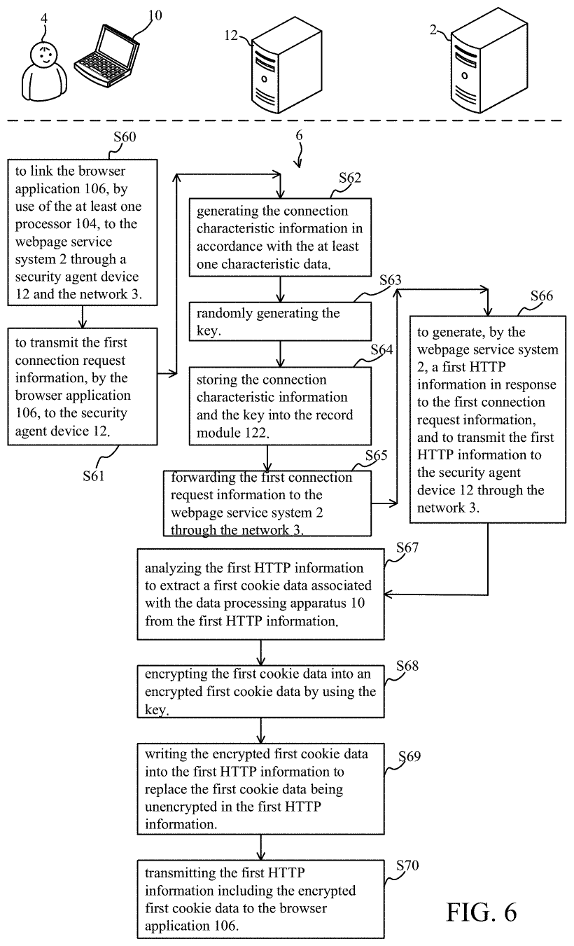

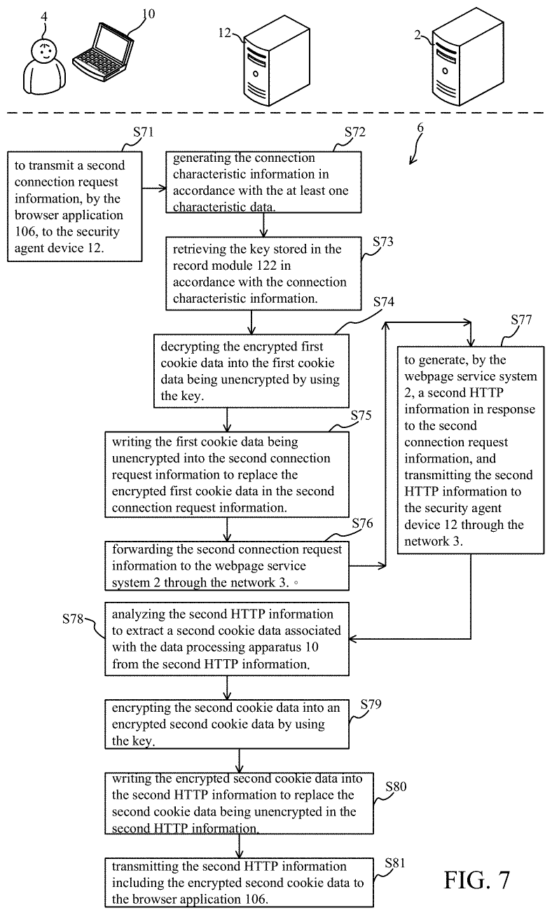

Referring to FIG. 6 and FIG. 7, FIG. 6 and FIG. 7 are flow diagrams illustrating a managing method 6 for managing certification for the webpage service system 2 in accordance with the preferred embodiment of the invention. Regarding the implementation environment of the managing method 6 according to the invention, please refer to the implementation architecture diagrams shown in FIG. 1 and FIG. 3, and refer to the functional block diagrams, shown in FIG. 2, FIG. 4 and FIG. 5, of the managing system 1 for managing certification for the webpage service system 2. The data processing apparatus 10 is capable of being linked to the webpage service system 2 through the network 3. The data processing apparatus 10 includes the data storage unit 102 and the at least one processor 104. The browser application 106 is stored in the data storage unit 102. The at least one processor 104 is electrically connected to the data storage unit 102.

Firstly, as shown in FIG. 6, the managing method 6 according to the invention performs step S60 to link the browser application 106, by use of the at least one processor 104, to the webpage service system 2 through a security agent device 12 and the network 3 when the user 4 operates the at least one processor 104 to execute the browser application 106 to link to the webpage service system 2, where the security agent device 12 includes the record module 122.

Next, the managing method 6 according to the invention performs step S61 to transmit the first connection request information, by the browser application 106, to the security agent device 12, where the first connection request information includes the at least one characteristic data associated with the data processing apparatus 10.

Then, the managing method 6 according to the invention is to perform, by the security agent device 12, the steps of: step S62—generating the connection characteristic information in accordance with the at least one characteristic data; step S63—randomly generating the key; step S64—storing the connection characteristic information and the key into the record module 122; and step S65—forwarding the first connection request information to the webpage service system 2 through the network 3.

In one embodiment, the security agent device 12 generates the salt in accordance with the connection characteristic information and the time, and randomly generates the key in accordance with the salt.

Subsequently, the managing method 6 according to the invention performs step S66 to generate, by the webpage service system 2, a first hypertext transfer protocol (HTTP) information in response to the first connection request information, and to transmit the first HTTP information to the security agent device 12 through the network 3.

Finally, the managing method 6 according to the invention is to perform, by the security agent device 12, the steps of: step S67—analyzing the first HTTP information to extract a first cookie data associated with the data processing apparatus 10 from the first HTTP information; step S68—encrypting the first cookie data into an encrypted first cookie data by using the key; step S69—writing the encrypted first cookie data into the first HTTP information to replace the first cookie data being unencrypted in the first HTTP information; and step S70—transmitting the first HTTP information including the encrypted first cookie data to the browser application 106.

Further, as shown in FIG. 7, the managing method 6 according to the invention also performs step S71 to transmit a second connection request information, by the browser application 106, to the security agent device 12 when the user 4 operates the at least one processor 104 to execute the browser application 106 to continuously link to the webpage service system 2, where the second connection request information includes the encrypted first cookie data and the at least one characteristic data associated with the data processing apparatus 10.

Next, the managing method 6 according to the invention is to perform, by the security agent device 12, the steps of: step S72—generating the connection characteristic information in accordance with the at least one characteristic data; step S73—retrieving the key stored in the record module 122 in accordance with the connection characteristic information; step S74—decrypting the encrypted first cookie data into the first cookie data being unencrypted by using the key; step S75—writing the first cookie data being unencrypted into the second connection request information to replace the encrypted first cookie data in the second connection request information; and step S76—forwarding the second connection request information to the webpage service system 2 through the network 3.

Then, the managing method 6 according to the invention performs step S77 to generate, by the webpage service system 2, a second HTTP information in response to the second connection request information, and transmitting the second HTTP information to the security agent device 12 through the network 3.

Finally, he managing method 6 according to the invention is to perform, by the security agent device 12, the steps of: step S78—analyzing the second HTTP information to extract a second cookie data associated with the data processing apparatus 10 from the second HTTP information; step S79—encrypting the second cookie data into an encrypted second cookie data by using the key; step S80—writing the encrypted second cookie data into the second HTTP information to replace the second cookie data being unencrypted in the second HTTP information; and step S81—transmitting the second HTTP information including the encrypted second cookie data to the browser application 106.

With the detailed description of the above preferred embodiments of the invention, it is clear to understand that a managing system and a managing method for managing certification for a webpage service system in accordance with the invention encrypt and decrypt cookie data in a third-party manner such that the browser application 106 receives the encrypted cookie data. Thereby, the managing system and the managing method according to the invention can prevent malicious intruders from fraudulently using their identities to obtain certification for the webpage service system, and can prevent users from bypassing the original security mechanism of the data processing system to obtain the certification for the webpage service system.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A managing system for managing certification for a webpage service system, comprising:
a data processing apparatus, capable of being linked to the webpage service system through a network, the data processing apparatus comprising:
a data storage unit, wherein a browser application is stored in the data storage unit; and
at least one processor, electrically connected to the data storage unit; and
a security agent device, capable of communicating with the data processing apparatus, the security agent device comprising:
a communication module;
a record module; and
a data processing module, respectively coupled to the communication module and the record module;
wherein when a user operates the at least one processor to execute the browser application to link to the webpage service system, the at least one processor makes the browser application to link to the webpage service system through the security agent device and the network, the browser application transmits a first connection request information to the security agent device, the first connection request information comprises at least one characteristic data associated with the data processing apparatus, the data processing apparatus receives the first connection request information through the communication module and then performs the steps of:
generating a connection characteristic information in accordance with the at least one characteristic data;
randomly generating a key, wherein the connection characteristic information corresponds to the key;
storing the connection characteristic information and the key into the record module; and
forwarding the first connection request information to the webpage service system through the communication module and the network;
the webpage service system generates a first hypertext transfer protocol (HTTP) information in response to the first connection request information, and transmits the first HTTP information to the data processing module through the network and the communication module, and then, the data processing module performs the steps of:
analyzing the first HTTP information to extract a first cookie data associated with the data processing apparatus from the first HTTP information;
encrypting the first cookie data into an encrypted first cookie data by using the key;
writing the encrypted first cookie data into the first HTTP information to replace the first cookie data being unencrypted in the first HTTP information; and
transmitting the first HTTP information comprising the encrypted first cookie data to the browser application through the communication module.

2. The managing system of claim 1, wherein when the user operates the at least one processor to execute the browser application to continuously link to the webpage service system, the browser application transmits a second connection request information to the security agent device, the second connection request information comprises the encrypted first cookie data and the at least one characteristic data associated with the data processing apparatus, the data processing module receives the second connection request information through communication module and then performs the steps of:
generating the connection characteristic information in accordance with the at least one characteristic data;
retrieving the key stored in the record module in accordance with the connection characteristic information;
decrypting the encrypted first cookie data into the first cookie data being unencrypted by using the key;
writing the first cookie data being unencrypted into the second connection request information to replace the encrypted first cookie data in the second connection request information; and
forwarding the second connection request information to the webpage service system through the communication module and the network;
the webpage service system generates a second HTTP information in response to the second connection request information, and transmits the second HTTP information to the data processing module through the network and the communication module, and then, the data processing module performs the steps of:
analyzing the second HTTP information to extract a second cookie data associated with the data processing apparatus from the second HTTP information;
encrypting the second cookie data into an encrypted second cookie data by using the key;
writing the encrypted second cookie data into the second HTTP information to replace the second cookie data being unencrypted in the second HTTP information; and
transmitting the second HTTP information comprising the encrypted second cookie data to the browser application through the communication module.

3. The managing system of claim 2, wherein the webpage service system is a first intranet web server or a first public cloud service server.

4. The managing system of claim 3, wherein the security agent device is a security agent application stored in the data storage unit, a second intranet server or a second public cloud service server.

5. The managing system of claim 4, wherein the at least one characteristic data comprise one selected from the group consisting of an internet protocol (IP) address, a media access control (MAC) address, a user agent, an X-Forwarded-Host (XFH) request header, a mobile phone number, a user identification code, and a user identity module identification code.

6. A managing method for managing certification for a webpage service system, wherein a data processing apparatus is capable of being linked to the webpage service system through a network, the data processing apparatus comprises a data storage unit and at least one processor, a browser application is stored in the data storage unit, the at least one processor is electrically connected to the data storage unit, said managing method comprising the steps of:
when a user operates the at least one processor to execute the browser application to link to the webpage service system, linking the browser application, by use of the at least one processor, to the webpage service system through a security agent device and the network, wherein the security agent device comprises a record module;
transmitting a first connection request information, by the browser application, to the security agent device, wherein the first connection request information comprises at least one characteristic data associated with the data processing apparatus;
performing, by the security agent device, the steps of:
generating a connection characteristic information in accordance with the at least one characteristic data;
randomly generating a key, wherein the connection characteristic information corresponds to the key;
storing the connection characteristic information and the key into the record module; and
forwarding the first connection request information to the webpage service system through the network;
by the webpage service system, generating a first hypertext transfer protocol (HTTP) information in response to the first connection request information, and transmitting the first HTTP information to the security agent device through the network;
performing, by the security agent device, the steps of:
analyzing the first HTTP information to extract a first cookie data associated with the data processing apparatus from the first HTTP information;
encrypting the first cookie data into an encrypted first cookie data by using the key;
writing the encrypted first cookie data into the first HTTP information to replace the first cookie data being unencrypted in the first HTTP information; and
transmitting the first HTTP information comprising the encrypted first cookie data to the browser application.

7. The managing method of claim 6, further comprising the steps of:
when the user operates the at least one processor to execute the browser application to continuously link to the webpage service system, transmitting a second connection request information, by the browser application, to the security agent device, wherein the second connection request information comprises the encrypted first cookie data and the at least one characteristic data associated with the data processing apparatus;
performing, by the security agent device, the steps of:
generating the connection characteristic information in accordance with the at least one characteristic data;
retrieving the key stored in the record module in accordance with the connection characteristic information;
decrypting the encrypted first cookie data into the first cookie data being unencrypted by using the key;
writing the first cookie data being unencrypted into the second connection request information to replace the encrypted first cookie data in the second connection request information; and
forwarding the second connection request information to the webpage service system through the network;
by the webpage service system, generating a second HTTP information in response to the second connection request information, and transmitting the second HTTP information to the security agent device through the network;
performing, by the security agent device, the steps of:
analyzing the second HTTP information to extract a second cookie data associated with the data processing apparatus from the second HTTP information;
encrypting the second cookie data into an encrypted second cookie data by using the key;
writing the encrypted second cookie data into the second HTTP information to replace the second cookie data being unencrypted in the second HTTP information; and
transmitting the second HTTP information comprising the encrypted second cookie data to the browser application.

8. The managing method of claim 7, wherein the webpage service system is a first intranet web server or a first public cloud service server.

9. The managing method of claim 8, wherein the security agent device is a security agent application stored in the data storage unit, a second intranet server or a second public cloud service server.

10. The managing method of claim 9, wherein the at least one characteristic data comprises one selected from the group consisting of an IP (internet protocol) address, a MAC (media access control) address, a user agent, an XFH (X-Forwarded-Host) request header, a mobile phone number, a user identification code, and a user identity module identification code.
